(19) United States
(12) Patent Application Publication
(10) Pub. No.: US 2015/0312452 A1
(43) Pub. Date: Oct. 29, 2015

(54) CLAMPING CLIP FOR CAMERA MODULE FOCUSING DURING ASSEMBLY

(71) Applicant: Apple Inc., Cupertino, CA (US)

(72) Inventor: Aurelien R. Hubert, Saratoga, CA (US)

(73) Assignee: Apple Inc., Cupertino, CA (US)

(21) Appl. No.: 14/261,314

(22) Filed: Apr. 24, 2014

(51) Int. Cl. H04N 5/225; F16B 2/20

(52) U.S. Cl. CPC H04N 5/2254; F16B 2/20

(57) ABSTRACT

A clamping clip for use in an assembly process for a camera module includes a sheet of ferromagnetic material that includes a first aperture that corresponds to a second aperture in a housing that encloses an actuator that moves a lens assembly. At least three positioning legs are attached to an outer periphery of the sheet of ferromagnetic material such that the at least three legs will closely engage side walls of the housing. At least three prongs are attached to the first aperture in the sheet of ferromagnetic material such that the prongs will engage a carrier coupled to the lens assembly to hold the carrier in a fixed position that allows the position of the lens assembly to be adjusted as part of the assembly process when the sheet of ferromagnetic material is retained on the housing by permanent magnets in the actuator.

### BACKGROUND

1. Field

Embodiments of the invention relate to the field of digital camera modules; and more specifically, to assembly fixtures for setting the initial focus position during assembly.

2. Background

Many portable electronic devices, such as mobile cellular telephones, include a digital camera. The lenses for such cameras must be compact to fit within the case of the portable electronic device. At the same time there is a desire to provide an increasingly high quality camera function in these devices. To provide a higher quality image, some cameras found in portable electronic devices provide an autofocus feature and/or optical image stabilization.

An image sensor, lens, and actuators for the lens are typically assembled into a camera module. The lens may be mounted in an autofocus actuator that moves the lens along its optical axis to change the distance between the lens and the image sensor. This changes the focal distance of the camera and allows a sharper image to be obtained for subjects over a greater range of distances from the camera.

The lens may be mounted in an actuator that moves the lens in the plane parallel to the surface of the image sensor to provide optical image stabilization. This allows the optical axis of the lens to me moved to compensate for movements of the camera module, such those due to a lack of stability when the camera is handheld. The lens may be mounted in an actuator that provides both autofocus and optical image stabilization. One actuator for moving a lens is a voice coil motor.

The actuator may includes a carrier that is moved by the actuator. The lens is supported in turn by the carrier. The carrier may be supported within the camera module by a spring suspension. The spring suspension typically provides a restoring force that is just sufficient for the mass of the lens and carrier assembly to minimize the amount of energy required by the actuator to move the lens and carrier assembly.

The camera module generally includes a stop that limits the movement of the carrier along the optical axis of the lens as it approaches the image sensor. The lens will be in focus for objects at a greater distance from the camera when the lens is closer to the image sensor. When the carrier is against the stop, the lens should be at the position where very distant objects are in focus, a setting that is termed infinity focus. The lens and/or actuator are adjusted during assembly so that the lens is positioned within the carrier when the carrier is against the stop to provide infinity focus.

In some actuators the spring suspension will hold the carrier against the stop when the actuator is not energized. In other actuators the spring suspension will hold the carrier away from the stop when the actuator is not energized. In actuators that provide optical image stabilization the spring suspension will hold the carrier at the optical axis of the image sensor assembly when the actuator is not energized.

In a typical camera module assembly process, the actuator assembly may be mounted on the substrate using high accuracy pick and place equipment. The pick and place process may include placement, bonding and adhesive flashing. The tilt and focus of the lens may be adjusted during the pick and place process by positioning the lens as held by the actuator assembly in all directions, three axes of translation axis and three axes of rotation. An optical target may be used to determine the best position for the lens.

It will be appreciated that the carrier may move within the spring suspension due to movement or vibration of the camera module when the actuator is not energized. It will be appreciated that it may be difficult or impossible to energize the actuator during the assembly of the camera module when the lens and/or actuator are being adjusted to provide infinity focus. The movement and vibration from the pick and place equipment may cause the carrier to move making the positioning of the lens more difficult.

It would be desirable to provide a mechanism for holding a carrier of a camera module actuator in the correct position for adjusting the position of the lens and/or actuator to provide infinity focus during assembly of the camera module.

### SUMMARY

A clamping clip for use in an assembly process for a camera module includes a sheet of ferromagnetic material that includes a first aperture that corresponds to a second aperture in a housing that encloses an actuator that moves a lens assembly. At least three positioning legs are attached to an outer periphery of the sheet of ferromagnetic material such that the at least three legs will closely engage side walls of the housing. At least three prongs are attached to the first aperture in the sheet of ferromagnetic material such that the prongs will engage a carrier coupled to the lens assembly to hold the carrier in a fixed position that allows the position of the lens assembly to be adjusted as part of the assembly process when the sheet of ferromagnetic material is retained on the housing by permanent magnets in the actuator.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

Embodiments of the invention will now be described with reference to the drawings summarized below. The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one.

FIG. 1 is a perspective view of a camera module separated from a clamping clip that embodies the invention.

FIG. 2 is a perspective view of the camera module shown in FIG. 1 with the clamping clip applied to the camera module.

FIG. 3 is a sectional view of the camera module and the clamping clip taken along section line 3-3 in FIG. 2.

FIG. 4 is a sectional view of the camera module and the clamping clip taken along section line 3-3 in FIG. 2 with an alternate carrier.

### DETAILED DESCRIPTION

Several embodiments of the invention with reference to the appended drawings are now explained. Whenever the shapes, relative positions, and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

In the following description, reference is made to the accompanying drawings, which illustrate several embodiments of the present invention. It is understood that other embodiments may be utilized, and mechanical compositional, structural, electrical, and operational changes may be made without departing from the spirit and scope of the present disclosure. The following detailed description is not to be taken in a limiting sense, and the scope of the embodiments of the present invention is defined only by the claims of the issued patent.

The terminology used herein is for the purpose of describing particular embodiments only and is not intended to be limiting of the invention. Spatially relative terms, such as “beneath”, “below”, “lower”, “above”, “upper”, and the like may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (e.g., rotated 90 degrees or at other orientations) and the spatially relative descriptors used herein interpreted accordingly.

As used herein, the singular forms “a”, “an”, and “the” are intended to include the plural forms as well, unless the context indicates otherwise. It will be further understood that the terms “comprises” and/or “comprising” specify the presence of stated features, steps, operations, elements, and/or components, but do not preclude the presence or addition of one or more other features, steps, operations, elements, components, and/or groups thereof.

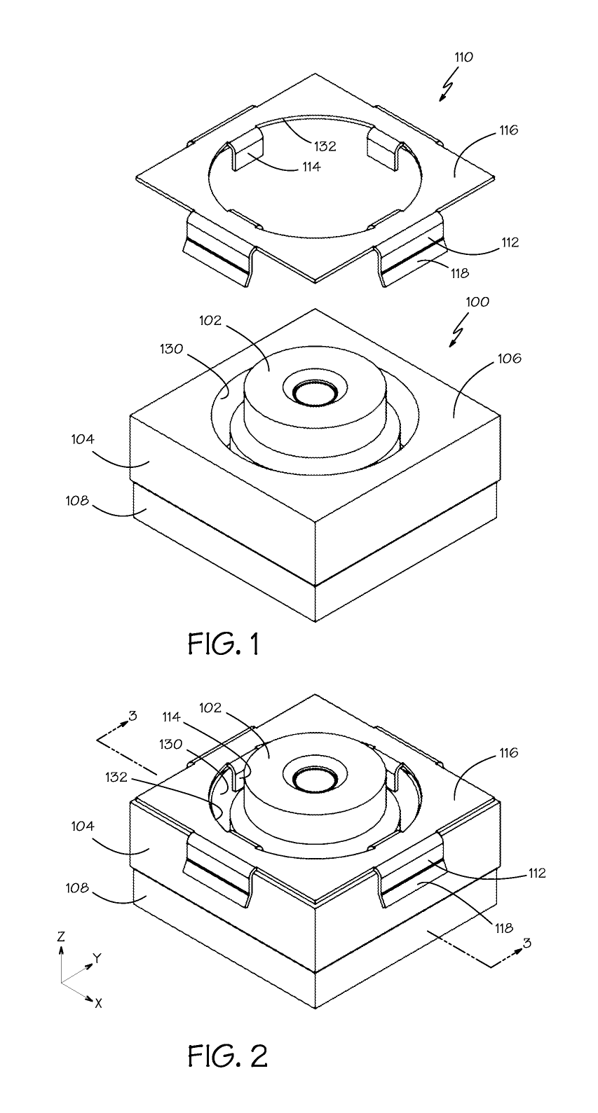

FIG. 1 is a perspective view of a camera module 100 and a clamping clip 110 that embodies the invention. The clamping clip 110 has not yet been applied to the camera module 100. The camera module will include a lens assembly 102, an actuator assembly 104, and a substrate assembly 108 when fully assembled. While a fully assembled camera module 100 is illustrated, the clamping clip 110 may be used in the assembly process for the camera module 100 at times when not all assemblies are present.

FIG. 2 is a perspective view of the camera module 100 and the clamping clip 110 shown in FIG. 1 with the clamping clip applied to the camera module. When the clamping clip is applied to the camera module, the carrier (not visible) is held in a fixed position where the lens assembly 102 should provide infinity focus.

The clamping clip 110 includes three or more positioning legs 112 that engage the outer surface of the housing 104 of the camera module 100. The housing 104 encloses an actuator that moves a lens assembly 102. The legs 112 provide a means for engaging the side walls of the housing 104 to locate the clamping clip 110 in the X and Y directions. The engagement of the positioning legs 112 with the outer surfaces of the actuator assembly housing 104 also prevents rotation of the clamping clip 110 about the optical axis of the lens assembly 102.

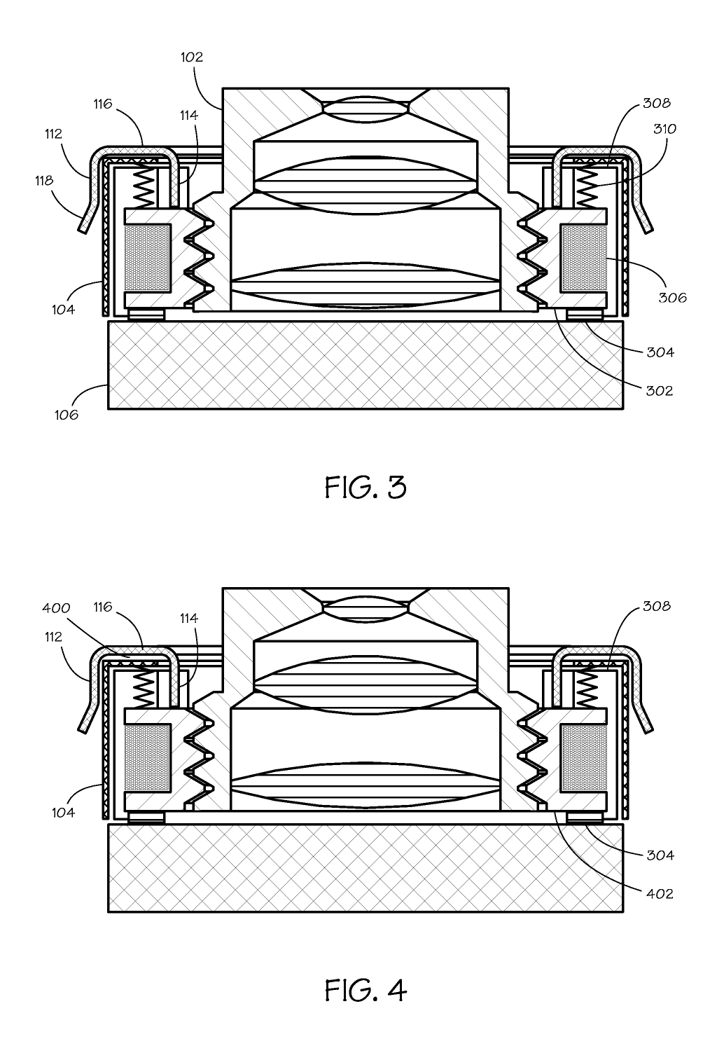

FIG. 3 is a sectional view of the camera module 100 and the clamping clip 110 taken along section line 3-3 in FIG. 2. The lens assembly 102 is coupled to a carrier 302. The lens assembly 102 may be coupled to the carrier 302 by a threaded connection as shown or by another form of coupling that allows the position of the lens assembly in the carrier to be adjusted during the assembly of the camera module 100. The lens assembly 102 will generally be fixed to the carrier 302 when the lens position has been adjusted.

The carrier 302 may be positioned by an actuator, which may be a voice coil motor as shown or by another form of actuator that can provide the necessary movement of the carrier and the coupled lens assembly 102. The voice coil actuator shown includes an electromagnetic coil 306 that is wound around the carrier 302. The carrier is surrounded by permanent magnets 308 that create a magnetic field. In the actuator assembly 104 shown, the permanent magnets 308 are placed at the four corners of the actuator assembly. When electric current is supplied to the electromagnetic coil 306, the coil creates a magnetic field that interacts with the magnetic field created by the permanent magnets 308 to create forces that move the carrier 302 within the actuator assembly 104.

One or more springs 310 are coupled to the carrier 302 to urge the carrier to a resting position when the electromagnetic coil 306 in not energized. In the embodiment shown, the springs 310 urge the carrier 302 to a resting position against a stop 304 that limits the movement of the carrier and the coupled lens assembly 102 toward the substrate assembly 108 that includes the image sensor. In other embodiments, the springs may allow the lens assembly to move parallel to the surface of the image sensor and/or to rotate. In other embodiments, the springs may urge the carrier 302 to a resting position away from the stop 304.

The clamping clip 110 includes three or more prongs 114 that engage the carrier 302 and press it toward the image sensor in the substrate 106 and against the stop 304 in the camera module 100. The prongs 114 provide a means for fixing a position of the carrier 302 and the coupled lens assembly 102. Holding the carrier 302 against the stop 304 locates the clamping clip 110 and the carrier in the Z direction. The engagement of the prongs 114 with the carrier 302 may also prevent translation and rotation of the carrier about any of the remaining five axes of motion.

The clamping clip 110 may cooperate with the springs 310 to hold the carrier 302 in the resting position provided by the springs. In other embodiments the clamping clip 110 may overcome the spring forces to hold the carrier in a position other than the resting position provided by the springs.

The clamping clip 110 is formed from a sheet of ferromagnetic material with a size and shape that corresponds to an exterior surface of the housing that encloses the actuator 104. The portion 116 of the clamping clip 110 that is placed adjacent to the second aperture 130 in the housing 104 provides a means for retaining the clamping clip 110 on the housing by attraction to the permanent magnets 308 in the actuator.

The sheet of ferromagnetic material includes a first aperture 132 that corresponds to a second aperture 130 in the housing 104 that provides an opening for optics of the lens assembly 102. The first aperture 132 provides a means for allowing light to pass through the clamping clip 110 and into the lens assembly 102 when the clamping clip is retained on the housing 104.

The first aperture 132 may also provide a means for allowing the lens assembly 102 to be positioned with respect to the substrate 106 when the clamping clip 110 is retained on the housing 104. The first aperture 132 may provide mechanical access to the lens assembly 102 through the clamping clip 110 when the clamping clip is retained on the housing 104. This may allow the lens assembly 102 to be moved within the carrier 302 to focus a test image formed by the optics on an image sensor in the substrate 106 of the camera module 100.

At least three positioning legs 112 are attached to an outer periphery of the sheet of ferromagnetic material 116 such that the at least three legs will closely engage side walls of the housing 104. Each positioning leg 112 may include a sloped surface 118 at the end of the leg furthest from the outer periphery of the sheet of ferromagnetic material 116. The sloped surface 118 slopes away from the side walls of the housing 104 when the legs 112 engage the side walls of the housing. The sloped surfaces 118 may aid in engaging the legs 112 with the side walls of the housing 104. The sloped surfaces 118 may form an angle between the sloped surface and the side walls of between 20 and 30 degrees. Thus the sloped surfaces 118 provide a means for guiding the legs 112 into engagement with the side walls of the housing 104.

At least three prongs 114 are attached to the first aperture 132 in the sheet of ferromagnetic material 116. The prongs 114 engage a carrier 302 coupled to the lens assembly 102. The prongs 114 hold the carrier 302 in a fixed position that allows the position of the lens assembly 102 to be adjusted as part of the assembly process when the sheet of ferromagnetic material 116 is retained on the housing 104 by magnetic attraction of permanent magnets 308 in the actuator. Each prong 114 may include a shaped edge at the end of the prong furthest from the first aperture 132 in the sheet of ferromagnetic material. The shaped edge may have a shape that engages a corresponding portion of the carrier 302.

FIG. 4 is a sectional view of the camera module 100 and the clamping clip 110 taken along section line 3-3 in FIG. 2. In this view the carrier 402 is shown as having a greater thickness, as may be the case for some parts within the dimensional tolerances permitted. In this case there will be a gap 400 when the sheet of ferromagnetic material 116 is retained against the housing 104 by magnetic attraction of permanent magnets 308 in the actuator. There may also be a gap based on the dimensional tolerances for the clamping clip 110 and particularly for a length of the prongs 114. The use of the permanent magnets 308 to retain the clamping clip 110 allows the existence of a gap 400 to be accommodated.

The clamping clip 110 may be formed from a single sheet of ferromagnetic material with the positioning legs 112 and the prongs 114 being formed and folded to form the clamping clip. A commercial quality cold rolled steel, such as SPCC steel having a material grade and designation defined in the JIS G 3141 standard, is a suitable material for the clamping clip 110. The clamping clip may be plated, such as with a nickel plating, to improve the durability of the clamping clip.

It will be appreciated that the clamping clip 110 needs to be precisely formed with a close fit in the X and Y directions on the housing 104 to function properly. The distance between inside surfaces of opposing positioning legs 112 may be 40 to 160 microns (1575 to 6300 microinches) greater than a distance between outside surfaces of opposing side walls of the housing 104.

The ferromagnetic clamping clip 110 is used in assembling a camera module 100 that includes an actuator that moves a lens assembly 102. The method of assembling the camera module 100 includes applying the clamping clip 110 to hold a carrier 302 coupled to the lens assembly 102 in a fixed position.

The ferromagnetic clamping clip 110 has at least three positioning legs 112 that closely engage side walls of a housing 104 that encloses the actuator and at least three prongs 114 that engage the carrier 302 when the ferromagnetic clamping clip is retained on the housing by permanent magnets 308 in the actuator.

The lens assembly 102 is then positioned with respect to the substrate 106 while the carrier 302 is held in the fixed position by the clamping clip 110. The lens assembly 102 may be fixed to the carrier 302 after positioning the lens assembly with respect to the substrate 106 to provide a permanent adjustment of the lens assembly at an infinity focus when the carrier is positioned against a mechanical stop 304 in the camera module 100. Positioning the lens assembly 102 may include moving the lens assembly 102 within the carrier 302 to focus a test image formed by the optics on an image sensor included in the substrate 106 of the camera module 100.

For purposes of explanation, specific embodiments were described to provide a thorough understanding of the present invention. These should not be construed as limiting the scope of the invention but merely as illustrating different examples and aspects of the invention. It should be appreciated that the scope of the invention includes other embodiments not discussed in detail above. Various other modifications, changes, and variations which will be apparent to those skilled in the art may be made in the arrangement, operation, and details of the systems and methods of the present invention disclosed herein without departing from the spirit and scope of the invention as defined in the appended claims. Therefore, the scope of the invention should be determined by the claims and their legal equivalents. Such equivalents include both currently known equivalents as well as equivalents developed in the future, i.e. any elements developed that perform the same function, regardless of structure. Furthermore, no element, component, or method step is intended to be dedicated to the public regardless of whether the element, component, or method step is explicitly recited in the claims.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those of ordinary skill in the art. The description is thus to be regarded as illustrative instead of limiting.

What is claimed is:

1. A clamping clip for use in an assembly process for a camera module, the clamping clip comprising:
a sheet of ferromagnetic material that includes a first aperture that corresponds to a second aperture in a housing that encloses an actuator that moves a lens assembly;
at least three positioning legs that are attached to an outer periphery of the sheet of ferromagnetic material such that the at least three positioning legs will closely engage side walls of the housing; and
at least three prongs that are attached to the first aperture in the sheet of ferromagnetic material such that the at least three prongs will engage a carrier coupled to the lens assembly to hold the carrier in a fixed position that allows a position of the lens assembly to be adjusted as part of the assembly process when the sheet of ferromagnetic material is retained on the housing by permanent magnets in the actuator.

2. The clamping clip of claim 1, wherein each positioning leg includes a sloped surface at an end of the positioning leg furthest from the outer periphery of the sheet of ferromagnetic material that slopes away from the side walls of the housing when the positioning leg engages the side walls of the housing.

3. The clamping clip of claim 2, wherein an angle between the sloped surface and the side walls is between 20 and 30 degrees.

4. The clamping clip of claim 1, wherein each prong includes a shaped edge at an end of the prong furthest from the first aperture in the sheet of ferromagnetic material, the shaped edge having a shape that engages a corresponding portion of the carrier.

5. The clamping clip of claim 1, wherein the positioning legs and the prongs are formed from the sheet of ferromagnetic material and folded to form the clamping clip.

6. The clamping clip of claim 1, wherein a distance between inside surfaces of opposing positioning legs is 40 to 160 microns (1575 to 6300 microinches) greater than a distance between outside surfaces of opposing side walls of the housing.

7. The clamping clip of claim 1, wherein the clamping clip is plated with nickel.

8. The clamping clip of claim 1, wherein the second aperture provides an opening for optics of the lens assembly.

9. A method of assembly for a camera module, the method comprising:
applying a ferromagnetic clamping clip to hold a carrier in a fixed position, the ferromagnetic clamping clip having
at least three positioning legs that closely engage side walls of a housing that encloses an actuator that moves the carrier and a lens assembly coupled to the carrier, and
at least three prongs that engage the carrier when the ferromagnetic clamping clip is retained on the housing by permanent magnets in the actuator; and
positioning the lens assembly with respect to a substrate while the carrier is held in the fixed position by the ferromagnetic damping clip.

10. The method of assembly of claim 9, further comprising fixing the lens assembly to the carrier after positioning the lens assembly with respect to the substrate.

11. The method of assembly of claim 9, wherein positioning the lens assembly includes moving the lens assembly within the carrier to focus a test image formed by the lens assembly on an image sensor in the camera module.

12. A clamping clip for use in an assembly process for a camera module, the clamping clip comprising:
means for engaging side walls of a housing of the camera module that encloses an actuator that moves a lens assembly;
means for retaining the clamping clip on the housing by attraction to permanent magnets in the actuator; and
means for fixing a position of a carrier coupled to the lens assembly.

13. The clamping clip of claim 12, further comprising means for guiding the means for engaging the side walls of the housing into engagement.

14. The clamping clip of claim 13, wherein the means for guiding includes a sloped surface.

15. The clamping clip of claim 14, wherein the sloped surface of the means for guiding forms an angle between 20 and 30 degrees between the sloped surface and one of the side walls of the housing.

16. The clamping clip of claim 12, wherein the means for fixing the position of the carrier includes a shaped edge having a shape that engages a corresponding portion of the carrier.

17. The clamping clip of claim 12, further comprising means for allowing light to pass through the clamping clip and into the lens assembly when the clamping clip is retained on the housing.

18. The clamping clip of claim 12, further comprising means for allowing the lens assembly to be positioned with respect to a substrate when the clamping clip is retained on the housing.

19. The clamping clip of claim 18, wherein the means for allowing the lens assembly to be positioned provides mechanical access to the lens assembly through the clamping clip when the clamping clip is retained on the housing.

20. The clamping clip of claim 12, further comprising:
means for allowing light to pass through the clamping clip and into the lens assembly when the clamping clip is retained on the housing; and
means for allowing the lens assembly to be positioned with respect to a substrate when the clamping clip is retained on the housing;
such that the lens assembly can be moved within the carrier to focus a test image formed by the lens assembly on an image sensor in the substrate of the camera module.
